(19) United States
(12) Patent Application Publication
(10) Pub. No.: US 2025/0166353 A1
(43) Pub. Date: May 22, 2025

(54) DEVICES AND METHOD FOR AUTOMATICALLY IDENTIFYING AND CATEGORIZING WASTE, AND DIRECTING A DESIRED USER ACTION

(71) Applicant: SmartSort Technologies, Inc., Plano, TX (US)

(72) Inventors: Cristopher Luce, Plano, TX (US); Clifton Luce, Plano, TX (US); John Pacione, Plano, TX (US)

(73) Assignee: SmartSort Technologies, Inc., Plano, TX (US)

(21) Appl. No.: 19/033,161

(22) Filed: Jan. 21, 2025

Related U.S. Application Data
(63) Continuation-in-part of application No. 17/736,078, filed on May 3, 2022.
Application No. 17/736,078 is a continuation-in-part of application No. 16/826,213, filed on Mar. 21, 2020, now Pat. No. 11,335,086.

(51) Int. Cl. G06V 10/764; G06V 20/52

(52) U.S. Cl. CPC G06V 10/764; G06V 20/52; G06V 2201/09

(57) ABSTRACT

Embodiment herein discloses methods and devices for waste management by using an artificial intelligence based waste object categorizing engine. The method includes receiving an image while detecting a waste disposal activity (WDA) on a first waste bin and a second waste bin. Further, the method includes generating an entity identifier (EID) during a material disposal event (MDE) and associating the entity identifier with the material disposal event generated during the waste disposal activity. The method also includes identifying and displaying a brand, a product, a material, a usage of the material and a service information from the received image using a data driven assisted vision-based component based on the entity identifier. The method also includes identifying a waste stream type in the first waste bin and the second waste bin.

### CLAIM OF PRIORITY

The present invention is related and claims priority as a Continuation of US Non-Provisional application Ser. No. 16/826,213 entitled METHODS AND ELECTRONIC DEVICES FOR AUTOMATED WASTE MANAGEMENT filed on Mar. 21, 2020 and a Continuation of US Non-Provisional application Ser. No. 17/736,078 entitled DEVICE AND METHOD FOR AUTOMATICALLY IDENTIFYING AND CATEGORIZING WASTE, AND DIRECTING A DESIRED USER ACTION filed on May 3, 2022 having common inventor Wolfgang Decker.

### FIELD OF THE INVENTION

The present invention relates to waste management systems, and more particularly, to devices and methods that automate waste management.

### BACKGROUND

### Interpretation Considerations

This section describes technical field in detail and discusses problems encountered in the technical field. Therefore, statements in the section are not to be construed as prior art.

### Discussion of History of the Problem

Common existing waste disposal systems include unclassified garbage collected from various places which are then manually separated at a waste disposal facility. The manual separation of solid waste brings health hazards for waste sorters as well as is less efficient, time consuming and not completely feasible due to the large quantity of waste disposed by modern households, business, and industry. To make a waste disposal system efficient, an automatic waste disposal system is needed for sorting, processing, crushing, compacting, and rinsing the waste using an identifier (e.g., barcode identifier, or the like).

In order to make this process efficient, various methods and systems have been introduced in the prior arts. U.S. patent Ser. No. 10/943,897 (Kline et al) discloses a waste material recovery and conversion center/power plant, to replace traditional trash transfer stations and landfills.

U.S. Pat. No. 7,269,516 (Brunner et al) discloses mining experiment information to identify pattern(s) from data measurement databases collected from observation.

U.S. patent Ser. No. 15/963,755 (Kumar et al) discloses a material sorting system that sorts materials utilizing a vision and/or x-ray system that implements a machine learning system in order to identify or classify each of the materials, which are then sorted into separate groups based on such an identification or classification.

U.S. patent Ser. No. 16/177,137 (Horowitz et al) discloses systems for optical material characterization of waste materials using machine learning. Further, the U.S. patent Ser. No. 16/247,449 (Parr et al) discloses a system control for a material recovery (or recycling) facility.

However, in the prior arts, dating back over many decades, there is no automated method and system for the waste management that is accurate. Therefore, there is a long-felt need for an inventive approach that can overcome the limitations associated with conventional waste management techniques. In order to solve these problems, the present invention provides an automated device, system and method for waste management that is fast and accurately reliable.

### SUMMARY

The present invention discloses an artificial intelligence based method and system for an automatic waste management.

The method includes providing at least one first waste bin and at least one second waste bin. The at least one first waste bin has a local repository and the at least one second waste bin has a local repository. The at least one first waste bin has a data driven assisted vision-based component. Further, the method includes receiving, by an electronic device, at least one image while detecting a waste disposal activity (WDA) on the at least one first waste bin and the at least one second waste bin. Further, the method includes generating, by the electronic device, an entity identifier (EID) during at least one material disposal event (MDE). Further, the method includes associating, by the electronic device, the at least one entity identifier with the at least one material disposal event generated during the waste disposal activity. In an embodiment, the method includes identifying at least one of: a brand, a product, a material, a usage of the material and a service information from the received image using the data driven assisted vision-based component based on the at least one entity identifier. In another embodiment, the method includes displaying at least one of: the identified brand, the identified product, the identified material, the identified usage of the material and the identified service information using the data driven assisted vision-based component. In another embodiment, the method includes identifying a waste stream type in at least one of: the at least one first waste bin and the at least one second waste bin. In another embodiment, the method includes classifying and rating the waste stream type in at least one of: the at least one first waste bin and the at least one second waste bin. In another embodiment, the method includes determining a weight of the waste stream type in at least one of: the at least one first waste bin and the at least one second waste bin.

In an embodiment, the method includes performing, by the electronic device, a proprietary cloud synchronization, at a cloud storage component, for the at least one first waste bin and the at least one second waste bin. Further, the method includes determining, by the electronic device, at least one synchronization feedback associated with the proprietary cloud synchronization for the at least one first waste bin and the at least one second waste bin. In an embodiment, the method includes optimizing to identify at least one of: the brand, the product, the material, the usage of the material and the service information using the data driven assisted vision-based component based on the at least one synchronization feedback. In another embodiment, the method includes optimizing to display at least one of: the identified brand, the identified product, the identified material, the identified usage of the material and the identified service information using the data driven assisted vision-based component based on the at least one synchronization feedback. In another embodiment, the method includes optimizing to identify the waste stream type in at least one of: the at least one first waste bin and the at least one second waste bin based on the at least one synchronization feedback. In another embodiment, the method includes optimizing to classify and rate the waste stream type in at least one of: the at least one first waste bin and the at least one second waste bin based on the at least one synchronization feedback. In another embodiment, the method includes optimizing to determine a weight of the waste stream type in at least one of: the at least one first waste bin and the at least one second waste bin based on the at least one synchronization feedback.

In an embodiment, the method includes computing, by the electronic device, an average reusable weight factor across a plurality of waste items based on the at least one material disposal event.

In an embodiment, the method includes configuring, by the electronic device, a confidence factor (CF) for at least one of: a reusable materials accounting (RMA) process and a Carbon Accounting (CA) purpose, where the confidence factor determines the at least one MDE being sent for further analysis to enhance accuracy of the data driven assisted vision-based component.

In an embodiment, the method includes determining, by the electronic device, a visual characteristics of the at least one waste item based on the confidence factor. Further, the method includes assigning, by the electronic device, a configurable Average Reusable Weight (ARW) to the at least one waste item based on the visual characteristics of the at least one waste item and the confidence factor.

In an embodiment, the confidence factor determines at least one content associated with the at least one waste item to be identified after at least one object detection received from the data driven assisted vision-based component.

In an embodiment, the confidence factor is trained based on the data driven assisted vision-based component over a period of time.

In an embodiment, the method includes determining, by the electronic device, at least one Clustered Disposal Event (CDE). Further, the method includes performing, by the electronic device, at least one waste diversion activity for the at least one Clustered Disposal Event to identify at least one category of at least one waste item. The at least one category includes at least one of: a purchased goods category, a purchased service category, a sold product category, the at least one waste item for lessee, the at least one waste item for a lessor, the at least one waste item for franchises, the at least one waste item for a financial institution, the at least one waste item for end-of-life treatment of sold products, and the at least one waste item for waste generated in operations.

In an embodiment, indicating, by the electronic device, the weight of the waste stream to at least one of: a vehicle operator and a third party so as to maximize usage of a vehicle.

In an embodiment, the method includes alerting, by the electronic device, at least one of: a service provider and a third party to visit and change a trash bag associated with the at least one first waste bin and the at least one second waste bin.

In an embodiment, the method includes assigning, by the electronic device, at least one attribute associated with at least one event, wherein the at least one event comprises at least one of: a calendar event, a sports event, a government related event, a musical event, a movie related event, and a traveling event. In an embodiment, the method includes identifying at least one of: the brand, the product, the material, the usage of the material and the service information based on the at least one attribute associated with the at least one event. In another embodiment, the method includes displaying at least one of: the identified brand, the identified product, the identified material, the identified usage of the material and the identified service information using the data driven assisted vision-based component. In another embodiment, the method includes identifying the waste stream type in at least one of: the at least one first waste bin and the at least one second waste bin based on the at least one attribute associated with the at least one event. In another embodiment, the method includes classifying and rating the waste stream type in at least one of: the at least one first waste bin and the at least one second waste bin based on the at least one attribute associated with the at least one event. In another embodiment, the method includes determining the weight of the waste stream type in at least one of: the at least one first waste bin and the at least one second waste bin based on the at least one attribute associated with the at least one event.

In an embodiment, the method includes providing, by the electronic device, an option to place the at least one detected waste object in a library to either manually create a new classification for an unknown object, or properly align the at least one detected waste object with a correct classification in a pre-stored waste object and then add to an artificial intelligence based waste object categorizing engine to continue an artificial intelligence training process.

In an embodiment, the at least one Material Disposal Event (MDE) tracks the waste stream type with high granularity, so as to enable an advanced analytics and carbon accounting.

In an embodiment, the at least one MDE of the at least one first waste bin is associated with at least one of: a trash ID, a weight of the at least one waste item, an event associated with the at least one waste item, a total weight of the at least one first waste bin, an educational message, an advertisement, a material brand, and a user ID.

In an embodiment, the at least one MDE of the at least one second waste bin is associated with at least one of: a trash ID, a weight of the at least one waste item, an event associated with the at least one waste item and a total weight of the at least one second waste bin.

In an embodiment, the at least one first waste bin is an integrated waste bin and the at least one second waste bin is a connected waste bin.

Of course, the present is simply a summary, and not a complete description of the invention.

### BRIEF DESCRIPTION OF DRAWINGS

The preferred embodiment of the invention will hereinafter be described in conjunction with the appended drawings provided to illustrate and not to limit the scope of the invention, wherein like designation denote like element, prior art is explicitly identified as “Prior Art”, and in which:

FIG. 1 is a block diagram of an electronic device for waste management according to the teachings of the invention.

FIG. 2 is a block diagram of a system for waste management.

FIG. 3 is a block diagram of an artificial intelligence based waste object categorizing engine included in the electronic device for waste management.

FIG. 4 is a schematic diagram illustrating various layers in the artificial intelligence based waste object categorizing engine.

FIG. 5 is a flow chart illustrating a method for waste management.

FIG. 6 is an example flow chart illustrating various operations for waste management.

FIG. 7 is a flow chart illustrating various operations for creating a machine learning model in conjunction with the FIG. 5.

FIG. 8 is a flow chart illustrating various operations for training and maintaining the machine learning model in conjunction with the FIG. 5.

FIG. 9 is one perspective view of an inventive smart bin wastage sort device.

FIG. 10 is an alternative perspective view of a smart bin wastage sort device.

FIG. 11 is a partial sectional view of a collection can included in the smart bin wastage sort device.

FIG. 12 is a perspective view of a smart bin back panel included in the smart bin wastage sort device.

FIG. 13 is a perspective view of the smart bin wastage sort device including a visual indicator.

FIG. 14 is schematic view of an example system in which the smart bin wastage sort device communicates with a smart phone for waste management.

FIG. 15 is an example flow chart illustrating various operations for waste management.

FIG. 16 is an example illustration in which a system handles the waste management.

FIG. 17 is an example flow chart illustrating a method for training the machine learning model.

FIG. 18 is an example scenario in which transactional record of the material disposal event (MDE) is associated with a connected bin.

FIG. 19 is an example scenario in which transactional record of the MDE is associated with an integrated bin.

### DESCRIPTION OF AN EXEMPLARY PREFERRED EMBODIMENT

### Interpretation Considerations

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

In the following detailed description of embodiments of the invention, numerous specific details are set forth in order to provide a thorough understanding of the embodiment of invention. However, it will be obvious to a person skilled in the art that the embodiments of invention may be practiced with or without these specific details. In other instances, well known methods, procedures and components have not been described in detail so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

In a preferred embodiment, the present invention provides an artificial intelligence based waste object categorizing engine that is in selected embodiments custom designed (and may thus employ a using a custom designed and captured training model), and that is created from a machine learning method called deep learning method. The machine learning enables the artificial intelligence based waste object categorizing engine to automatically learn and improve from experience without being explicitly programmed.

The deep learning method uses networks capable of learning in an unsupervised fashion from data that is unstructured or unlabeled. The deep learning method employs multiple layers of neural networks that enable the artificial intelligence based waste object categorizing engine of the present invention to teach itself through inference and pattern recognition, rather than development of procedural code or explicitly coded software algorithms. The neural networks are modeled according to the neuronal structure of a mammal's cerebral cortex, wherein neurons represented as nodes and synapses represented as uniquely weighted paths between the nodes. The nodes are then organized into layers to comprise a network. The neural networks are organized in a layered fashion that includes an input layer, intermediate or hidden layers, and an output layer.

The neural networks enhance their learning capability by varying the uniquely weighted paths based on their received input. The successive layers within the neural network incorporates a learning capability by modifying their weighted coefficients based on their received input patterns. The training of the neural networks is very similar to how we teach children to recognize an object. The neural network is repetitively trained from a base data set, where results from the output layer are successively compared to the correct classification of the image.

In an alternate representation, any machine learning paradigm instead of neural networks can be used in the training and learning process.

Below is the list of reference numerals used in the patent disclosure:

| Reference Numeral | Element Name |
|---|---|
| 100 | Electronic device |
| 100a | First electronic device |
| 100b | Second electronic device |
| 100c | Smart bin wastage sort device |
| 100d | Smart phone |
| 102 | Processor |
| 104 | Communicator |
| 106 | Display |
| 106a | Information display |
| 108 | Memory |
| 110 | Artificial intelligence based waste object |
| | categorizing engine |
| 112 | Imaging unit |
| 112a | Digital camera |
| 112b | Digital camera array |
| 114 | Sensor |
| 114a | Distance sensor |
| 114b | Fill level sensor |
| 114c | Strain gauges |
| 116 | Bin housing |
| 118 | Smart bin back panel |
| 120 | Collection can |
| 122 | Housing door |
| 124 | Opening |
| 126 | Speaker |
| 128 | Optical indicator |
| 130 | Electronic scale |
| 132 | Power supply |
| 134 | Power distribution board |
| 136 | Mounting plate |
| 200 | System |
| 302 | Artificial intelligence model |
| 302a | Box generator |
| 302b | Shape identifier |
| 304 | Classifier |
| 306 | Machine learning model |
| 500 | Method for waste management |
| 600 | Various operations for waste management |
| 700 | Method for creating a machine learning |
| | model |
| 800 | Method for training and maintaining |
| | the machine learning model |
| 1500 | Method for waste management |
| 1600 | System for handling waste management |
| 1602 | Integrated bin |
| 1604 | Connected bin |
| 1606 | Non-relational cloud storage |
| 1612, 1616 | Local DB(s) |
| 1700 | Method for training a machine learning model |
| 1800 | Example scenario in which Transactional |
| | Record (MDE) is associated with connected |
| | bin |
| 1900 | Example scenario in which Transactional |
| | Record (MDE) is associated with integrated |
| | bin |

FIG. 1 is a block diagram of an electronic device 100 for waste management. The electronic device 100 can be, for example, but not limited to a smart sort artificial intelligence (AI) bin system, a smart bin wastage sort device, a smart waste separator, a smart phone, a smart internet of things (IoT) device, a smart server, or the like.

In one embodiment, the electronic device includes a processor 102, a communicator 104, a display 106, a memory 108, an artificial intelligence based waste object categorizing engine 110, an imaging unit 112, and a sensor 114. Although physical connections are not illustrated, the processor 102 is communicatively-coupled with the communicator 104, the display 106, the memory 108, the artificial intelligence based waste object categorizing engine 110, the imaging unit 112, and the sensor 114 in any manner known in the electronic arts.

The imaging unit 112 can be, for example but not limited to a standalone camera, a digital camera, a video, camera, infra-red (IR) or ultra-violet (UV) camera or the like. The sensor 114 can be, for example but not limited to a distance sensor, a fill level sensor, an electronic scale, strain gauges or the like.

In one embodiment, the imaging unit 112 acquires at least one image and shares the at least one acquired image to the artificial intelligence based waste object categorizing engine 110. In one example, the camera captures real-time digital images (e.g., RGB images or the like) or near real-time 2-dimensional digital images or continuous stream of digital images and adds a geo-tag to the acquired images, where the images may include multiple subjects. The multiple subjects include a user's hand on a waste object, the waste object on a tray, a background portion along with the acquired images. In another example, the digital camera captures a waste image and the sensor detects useful feature information from the waste image, then the digital camera and the sensor transfers the information to the artificial intelligence based waste object categorizing engine 110.

After receiving the at least one acquired image, the artificial intelligence based waste object categorizing engine 110 detects at least one waste object from the at least one acquired image. In an example, the artificial intelligence based waste object categorizing engine 110 processes continuous streams of the digital images or the acquired images to produce properly cropped images containing only the waste objects and minimal background for contextual understanding and increasing probability certainty related to the waste object.

In an alternative embodiment, the artificial intelligence based waste object categorizing engine 110 is configured to identify the at least one waste object from the at least one acquired image. Additionally, the artificial intelligence based waste object categorizing engine 110 is configured to extract the at least one identified waste object from the at least one acquired image by processing a foreground portion of the at least one acquired image and a background portion of the at least one acquired image. Based on the extraction, the artificial intelligence based waste object categorizing engine 110 is configured to determine at least one feature parameter. The feature parameter can be, for example but not limited to a shape of the waste object, a color of the waste object, an intensity of the waste object, an IR-detectable or UV-detectable image, a texture information of the of the waste object or the like.

In an example, the artificial intelligence based waste object categorizing engine 110 utilizes connected-component information corresponding to the acquired images to divide the image into pixels and detect foreground that are not part of a primary item of interest in the foreground image. This results in a bounding box around a main waste object to remove portions of other objects in the raw acquired image and processes the raw acquired images using AI algorithms or vision computer algorithms. Further, the artificial intelligence based waste object categorizing engine 110 creates the feature values representing how each pixel responded to the AI algorithms or the vision computer algorithms.

Based on the determined feature parameter, the artificial intelligence based waste object categorizing engine 110 is configured to analyze a pixel or pixels corresponding to the at least one identified waste object. Based on the analyzed pixel(s), the artificial intelligence based waste object categorizing engine 110 is configured to detect the at least one waste object from the at least one acquired image.

After detecting the at least one waste object from the at least one acquired image, the artificial intelligence based waste object categorizing engine 110 is configured to determine that the at least one detected waste object matches with a pre-stored waste object.

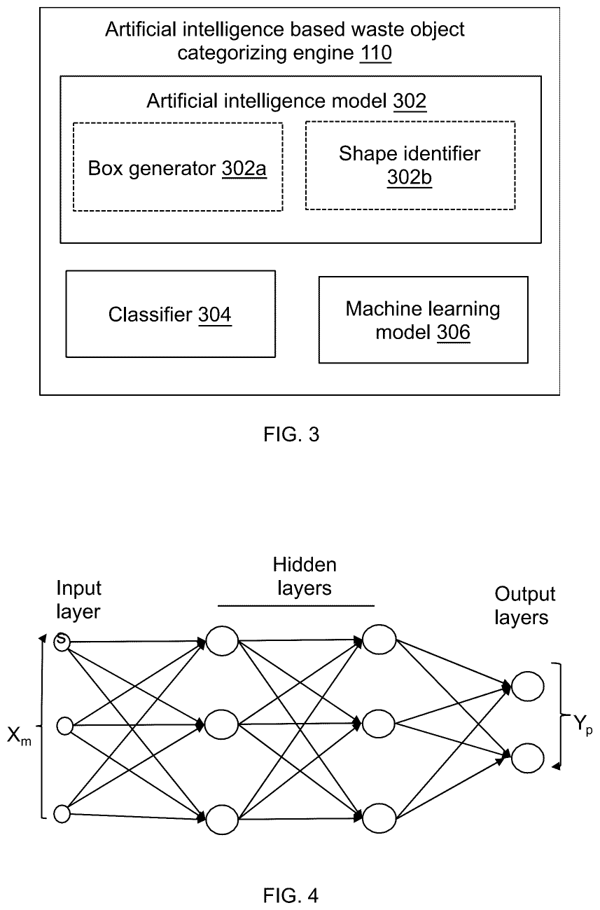

In an embodiment, the pre-stored waste object is generated by acquiring a waste object dataset comprising a set of waste object along with various categories, acquiring a portion of the image corresponding to the each set of waste object from the acquired waste object dataset, training the portion of the image corresponding to the each set of the waste object using a machine learning model 306, and generating the pre-stored waste object based on the trained portion of the image corresponding to the waste object. The machine learning model 306 is explained in conjunction with the FIG. 3.

By using the pre-stored waste object, the artificial intelligence based waste object categorizing engine 110 is configured to identify a type of the detected waste object. In an example, the artificial intelligence based waste object categorizing engine 110 is configured to identify the type of the detected waste object using a machine learning classifier or a filter. The type can be, for example, but not limited to a recyclable type, a trash type, a compost type, a reusable type, or the like. In an example, the images correspond to a glass, a cardboard, a metal, a paper, a Styrofoam, a food then, recycling type waste will be a glass, straws, aluminum and the trash type waste will be Styrofoam, coffee cups.

In an alternative embodiment, the artificial intelligence based waste object categorizing engine 110 is configured to determine whether multiple types of the detected waste object are detected. Alternatively, if multiple types of the waste object are not detected, the artificial intelligence based waste object categorizing engine 110 is configured to identify the type of the detected waste object using the at least one feature parameter.

In another embodiment, if multiple types of the waste object are detected, the artificial intelligence based waste object categorizing engine 110 determines the at least one feature parameter based on the at least one identified waste object, analyzes the pixel or pixels corresponding to the at least one identified waste object based on the determined feature parameter, and detects the at least one waste object from the at least one acquired image based on the analyzed pixel(s).

Based on identifying the type of the detected waste object, the artificial intelligence based waste object categorizing engine 110 is configured to display the type of the detected waste object on the display 106. The display 106 can be, for example, but not limited to, an information display, a LED display, an LCD display or the like.

Further, the artificial intelligence based waste object categorizing engine 110 is configured to notify the type of the detected waste object to a user using the communicator 104. The communicator 104 can be, for example, but not limited to, a Bluetooth communicator, a Wireless fidelity (Wi-Fi) communicator, a light fidelity (Li-Fi) communicator or the like. In an example, the notification is provided in the form of a visual alert through an audio using a speaker, LED's and on-screen messaging. In another example, the notification is provided in the form push messages to the user.

Further, the memory 108 comprises stored instructions, the instructions causing the artificial intelligence based waste object categorizing engine 110 to perform functions on the at least one image when executed by the at least one processor 102. The imaging unit 112 is connected with the processor 102 via the communicator 104 including a wired communication means or a wireless communication means such as, but not limited to, Bluetooth, near field communication, Wi-Fi, universal serial bus, or the like.

In an embodiment, if the images are colored images, then the artificial intelligence based waste object categorizing engine 110 utilizes to add extra information in order to assist in higher accuracy pixel classification. The accuracy of the artificial intelligence based waste object categorizing engine 110 is directly proportional to the quality of the images. The image resolution provides most effective classification of individual pixels and overall objects yet to be tested in various lighting conditions, backgrounds and variable scenarios. The camera image capture must be continuous (i.e., from point of detection to point of disposal). The images must be well lit, not distorted and as unobtrusive as possible.

Further, the artificial intelligence based waste object categorizing engine 110 uses multiple techniques including clustering, and a KNN classifier, but other classifiers can be used within the scope of the invention.

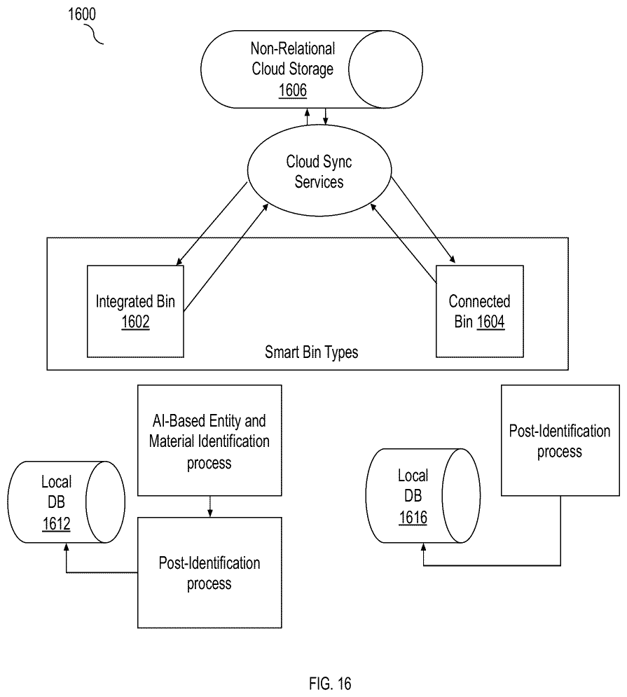

The artificial intelligence based waste object categorizing engine 110 receives the image of waste items while detecting a waste disposal activity (WDA) on a first waste bin and a second waste bin. The first waste bin may be an integrated waste bin (aka “integrated bin”) 1602 and the second waste bin may be a connected waste bin (aka “connected bin”) 1604. The first waste bin has a local repository 1612 and the second waste bin has a local repository 1616 (as sown in FIG. 16). The first waste bin has a data driven assisted vision-based component (e.g. AI assisted vision-based component or the like).

The artificial intelligence based waste object categorizing engine 110 is implemented within a smart waste management system, where the smart waste management system is designed to detect and classify the waste items that are being disposed of by users in two distinct types of waste bins: the integrated waste bin 1602 and the connected waste bin 1604. The integrated waste bin is equipped with advanced sensors, cameras, and an AI-powered system built into the bin(s) itself. The integrated waste bin 1602 is capable of automatically identifying waste objects as they are disposed therein. The artificial intelligence based waste object categorizing engine 110 categorizes the waste items in real-time based on material type, such as plastics, metals, organic waste, etc. The connected waste bin 1604 is a part of a larger network (not shown) of bins in the smart waste management system. The connected waste bin 1604 is connected to the cloud and communicates with other bins (not shown) in the larger network. The connected waste bin sends images of the waste items to a central server (not shown) or cloud-based system (not shown) for categorization. The artificial intelligence based waste object categorizing engine 110 monitors the waste disposal activity where these two bins are involved in a disposal process.

The artificial intelligence based waste object categorizing engine 110 generates an entity identifier (EID) during a material disposal event (MDE). The MDE tracks the waste stream type with high granularity, so as to enable an advanced analytics and carbon accounting, for example.

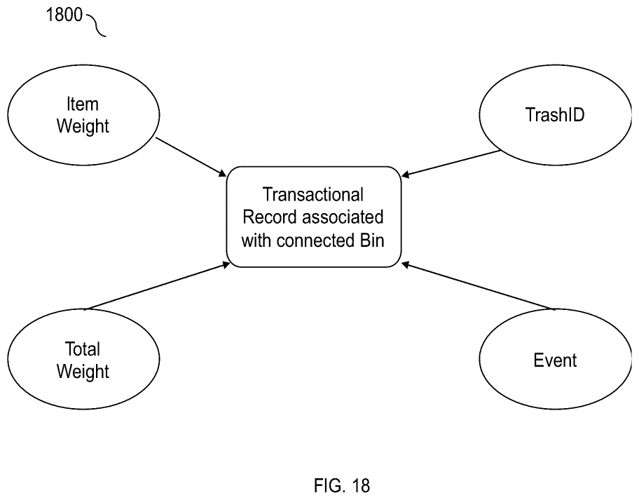

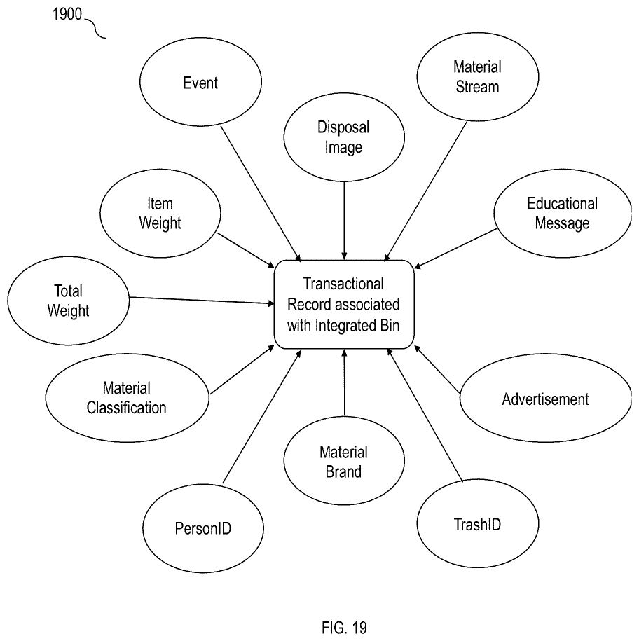

In an embodiment, the MDE of the first waste bin 1602 is associated with a transactional record having a trash ID, a weight of the waste item, an event associated with the waste item, a total weight of the first waste bin, an educational message, an advertisement, a material brand, and a user ID (personID), material classification, and a displosal image (as shown in FIG. 19, example scenario 1900). The MDE of the second waste bin 1604 is associated with another transactional record having a trash ID, a weight of the waste item, an event associated with the waste item and a total weight of the second waste bin (as shown in FIG. 18, example scenario 1800).

Further, the artificial intelligence based waste object categorizing engine 110 associates the entity identifier with the MDE generated during the waste disposal activity. That is, in the smart waste management system, the artificial intelligence based waste object categorizing engine 110 is designed to identify and classify the waste objects in real-time, while associating each disposal event with the specific entity identifier (such as user ID, location ID, or device ID). The user (for instance, a resident or employee) disposes of the waste item in the integrated bin 1602 equipped with AI sensors and cameras. The artificial intelligence based waste object categorizing engine 110 detects the waste object and classifies the waste object according to a material type (e.g., plastic, metal, organic, etc.). Each user and/or location in the system is assigned a unique entity identifier. This could be a QR code associated with a user's account, a user's RFID card, or a sensor-equipped waste bin that logs the disposal activity. The artificial intelligence based waste object categorizing engine 110 retrieves the entity identifier whenever the user interacts with the waste bin, either via a scan, a login, or sensor data associated with the particular bin (for example).

When the user disposes of waste in the bins, the material disposal event is created by the artificial intelligence based waste object categorizing engine 110. This event contains detailed information, including the type of waste (e.g., plastic bottle, food waste, paper or the like), the time of disposal and the location of the bin (e.g., home address, office floor, sports place etc.). The artificial intelligence based waste object categorizing engine 110 links the material disposal event to the specific entity identifier of the user, which could be the user's ID or the unique identifier of the smart waste bin. After the disposal event is detected, the artificial intelligence based waste object categorizing engine 110 associates the user's entity identifier (let's say, the user's unique ID or the bin's ID) with the material disposal event. For example, if a resident in an apartment building uses their smart waste bin, the artificial intelligence based waste object categorizing engine 110 notes the user's unique ID (e.g., “User12”) and associates this with a disposal event of a plastic bottle at time X and location Y. The material disposal event, now associated with the entity identifier, is logged in the smart waste management system. This data could be used for various purposes (e.g., waste management, and analytics and reporting).

The waste management process tracks how much recyclable or compostable waste the user disposed of at the specific location. The analytics and reporting monitors and generates reports on waste disposal behaviors by the location, the user, or the bin to optimize waste management practices.

By associating the entity identifier with each material disposal event, the artificial intelligence based waste object categorizing engine 110 can efficiently track, categorize, and analyse individual disposal activities. This helps create a more personalized and data-driven waste management experience.

The artificial intelligence based waste object categorizing engine 110 identifies and displays a brand, a product, a material, a usage of the material and a service information from the received image using the data driven assisted vision-based component based on the entity identifier. For example, in the smart waste management system, the artificial intelligence based waste object categorizing engine 110 analyzes the image of a disposed object to identify several key attributes associated with the item. When the user disposes of a plastic bottle in the integrated bin 1602, the artificial intelligence based waste object categorizing engine 110 processes the image using the data-driven, assisted vision-based component. Based on the entity identifier (e.g., the user's ID or the bin's location), the artificial intelligence based waste object categorizing engine 110 identifies the brand (e.g., “Coca-Cola®”, “Pepsi®” or the like), the product (e.g., “plastic beverage bottle”), the material (e.g., “PET plastic”), and the usage of the material (e.g., “used for holding carbonated drink”). Additionally, the artificial intelligence based waste object categorizing engine 110 retrieves and displays service information, such as whether the material is recyclable, the nearest recycling facility, or a recommendation for proper disposal. This information is then presented to the user, creating an informative and tailored waste disposal experience, while tracking and categorizing waste items based on both the object and the specific entity involved.

Further, the artificial intelligence based waste object categorizing engine 110 identifies a waste stream type in the first waste bin 1602 and the second waste bin 1604. For example, as the user disposes of items in the bins, the artificial intelligence based waste object categorizing engine 110 scans the contents of the integrated bin 1602, recognizes that it contains predominantly recyclable materials such as plastic bottles and aluminum cans, for example, and classifies it under the recyclable waste stream. Simultaneously, the artificial intelligence based waste object categorizing engine 110 processes the contents of the connected bin 1604, where the waste is composed mostly of food scraps and biodegradable materials, for example, categorizing it as organic waste. Based on this real-time analysis, the artificial intelligence based waste object categorizing engine 110 assigns each bin a corresponding waste stream type, ensuring that waste is sorted correctly for efficient processing and disposal.

The waste stream type can be, for example, but not limited to, a physical stream type and a virtual stream type. The physical stream type indicates a mixed and material specific recycle type, a mixed and material specific waste type, a mixed and material specific compost type and a mixed and material specific reusable type. The virtual stream type can be, for example, but not limited to, a mobile phone, smart watch or the like. Each trained material can be assigned to the stream for any given unit. Each stream has rules configured at the unit level and this dictates system behavior, including weight scales, advertisements, and educational messages.

In an embodiment, the artificial intelligence based waste object categorizing engine 110 acquires the image of the waste item/object. Then, the artificial intelligence based waste object categorizing engine 110 detects the waste object from the acquired image based on the foreground portion of the acquired image, and the background portion of the acquired image deriving feature parameter therefrom. Further, the artificial intelligence based waste object categorizing engine 110 determines the feature value corresponding to the feature parameter for pixel clarification associated with the acquired image. Further, the artificial intelligence based waste object categorizing engine 110 determines whether the detected waste object matches with the pre-stored waste object. If the detected waste object matches with the pre-stored waste object, the artificial intelligence based waste object categorizing engine 110 identifies the type of the detected waste object. Alternatively, when the type of the detected waste object is not identified, the artificial intelligence based waste object categorizing engine 110 places the detected waste object in a queuing library to manually create a new classification for an unknown object. Further, the artificial intelligence based waste object categorizing engine 110 properly aligns the detected waste object with a correct classification in the pre-stored waste object. Then, the artificial intelligence based waste object categorizing engine 110 adds the new classification to continue a training process. The artificial intelligence based waste object categorizing engine 110, then, identifies the waste stream type associated with the detected waste object in the first waste bin and the second waste bin.

The artificial intelligence based waste object categorizing engine 110 provides an option to the user to place the detected waste object in a library to either manually create a new classification for an unknown object, or properly align the detected waste object with a correct classification in a pre-stored waste object and then add to the artificial intelligence based waste object categorizing engine 110 to continue the artificial intelligence training process.

Further, the artificial intelligence based waste object categorizing engine 110 classifies and rates the waste stream type in the first waste bin and the second waste bin. In other words, the artificial intelligence based waste object categorizing engine 110 not only identifies the waste stream types in the first and second waste bins but also classifies and rates the waste based on its recyclability and environmental impact. For instance, as the user disposes of waste, the artificial intelligence based waste object categorizing engine 110 detects that the first waste bin contains a mix of plastics, glass bottles, and aluminum cans, and classifies them under the recyclable waste stream. The smart waste management system then rates the quality of recyclability and assigns a rating of “A” for high-quality recyclable materials. In contrast, the second waste bin primarily contains food waste and organic materials, categorizing it under the organic waste stream and rating it with a “B” for compostability. The artificial intelligence based waste object categorizing engine 110 uses these ratings to provide actionable insights, such as recommending the user to separate high-value recyclables from contaminated materials, or alerting waste management services to optimize bin collection based on the waste stream quality.

The artificial intelligence based waste object categorizing engine 110 also determines a weight of the waste stream type in the first waste bin 1602 and the second waste bin 1604. For example, as the user disposes of waste in the first waste bin, the artificial intelligence based waste object categorizing engine 110 identifies it as containing predominantly recyclable materials such as plastic bottles, aluminum cans, and glass containers. Using weight sensors and image recognition techniques, the artificial intelligence based waste object categorizing engine 110 computes the total weight of the recyclable waste in this bin. Similarly, in the second waste bin, which primarily holds organic waste like food scraps and paper towels, the artificial intelligence based waste object categorizing engine 110 computes the weight of the organic materials disposed of. This weight data is then used to optimize collection schedules, track waste generation trends, and ensure that the bins are not overloaded, improving overall waste management efficiency.

The artificial intelligence based waste object categorizing engine 110 performs a proprietary cloud synchronization, at a cloud storage component (e.g., non-relational cloud storage 1606), for the first waste bin and the second waste bin. In an example, as waste is disposed of in the bins, the artificial intelligence based waste object categorizing engine 110 categorizes and classifies the items, records details such as waste type, weight, and disposal time. The artificial intelligence based waste object categorizing engine 110 then synchronizes this data with a cloud storage component in real-time, securely uploads the information for both bins. For the first waste bin, which might primarily contain recyclable materials, and the second waste bin, which could contain organic waste, the synchronization ensures that all data from each bin is updated and stored in the cloud. This allows for easy retrieval of historical data, analysis of waste patterns, and integration with broader waste management systems, all while ensuring that the waste management process is optimized across multiple locations and users.

Further, the artificial intelligence based waste object categorizing engine 110 determines a synchronization feedback associated with the proprietary cloud synchronization for the first waste bin and the second waste bin.

The artificial intelligence based waste object categorizing engine 110 not only performs cloud synchronization for the first and second waste bins, but also determines the synchronization feedback to ensure that the data transfer is accurate and successful. After categorizing and classifying the waste in both bins, the artificial intelligence based waste object categorizing engine 110 uploads the relevant data to the cloud storage component. Once the data is successfully synced, the artificial intelligence based waste object categorizing engine 110 checks for any discrepancies or issues in the synchronization process, such as failed uploads or incomplete data. For instance, if the first waste bin has a significant amount of recyclable materials, the artificial intelligence based waste object categorizing engine 110 verifies that the weight, material type, and timestamp data have been properly transferred. Similarly, for the second waste bin, which contains organic waste, the artificial intelligence based waste object categorizing engine 110 ensures that the synchronization feedback confirms the accurate transmission of all relevant data. If any errors are detected, the artificial intelligence based waste object categorizing engine 110 triggers a feedback loop to attempt re-synchronization, alerting the waste management team if persistent issues arise, thus maintaining smooth operation and data integrity across the smart waste management system.

The synchronization feedback helps the artificial intelligence based waste object categorizing engine 110 in optimizing the identification and display of the brand, the product, the material, the usage of the material and the service information, the waste stream type in the first waste bin and the second waste bin using the data driven assisted vision-based component.

Also, the synchronization feedback helps the artificial intelligence based waste object categorizing engine 110 in optimizing the classification and rating of the waste stream type in the first waste bin and the second waste bin and optimizing the determination of the weight of the waste stream type in the first waste bin and the second waste bin.

Further, the artificial intelligence based waste object categorizing engine 110 computes an average reusable weight factor across a plurality of waste items based on the material disposal event. In other words, after the user disposes of various items in the waste bins, the artificial intelligence based waste object categorizing engine 110 analyzes the waste stream and identifies the materials such as plastic, metal, and paper. Then, the artificial intelligence based waste object categorizing engine 110 assigns the reusable weight factor to each item based on its recyclability and potential for reuse. In an example, the plastic bottles might have a weight factor of 0.8, while aluminum cans might be rated at 0.9 for high recyclability. The artificial intelligence based waste object categorizing engine 110 then calculates the average reusable weight factor by averaging the weight factors of all the disposed items in the material disposal event. If the first waste bin 1602 contains 5 plastic bottles (with a factor of 0.8) and 3 aluminum cans (with a factor of 0.9), the artificial intelligence based waste object categorizing engine 110 computes the average reusable weight factor for that bin. This calculated value helps the artificial intelligence based waste object categorizing engine 110 to evaluate the efficiency of waste disposal, monitor recycling trends, and make decisions about optimizing waste sorting and collection processes based on the overall recyclability of disposed materials.

Further, the artificial intelligence based waste object categorizing engine 110 configures a confidence factor (CF) for a reusable materials accounting (RMA) process and a Carbon Accounting (CA) purpose. The confidence factor determines the MDE being sent for further analysis to enhance accuracy of the data driven assisted vision-based component. The confidence factor determines a content associated with the waste item to be identified after the object detection received from the data driven assisted vision-based component. The confidence factor is trained based on the data driven assisted vision-based component over a period of time. The period of time is set by the user or the artificial intelligence based waste object categorizing engine 110.

After categorizing the waste disposed of in the smart bin, the artificial intelligence based waste object categorizing engine 110 assesses the quality of material identification, such as distinguishing recyclable plastics from contaminated ones. Based on the clarity of the image, the precision of material classification, and historical data on similar waste items, the artificial intelligence based waste object categorizing engine 110 assigns the confidence factor (CF) (i.e., a value that reflects the system's certainty in the classification). For the RMA process, a high CF indicates that the materials identified (e.g., PET plastic bottles or aluminum cans) are likely to be recycled, and the artificial intelligence based waste object categorizing engine 110 logs this with a high level of confidence factor. For carbon accounting (CA), the CF is used to calculate the potential reduction in carbon emissions based on the amount of reusable or recyclable materials, factoring in the estimated carbon savings from recycling. If the confidence factor in the waste stream classification is high, the artificial intelligence based waste object categorizing engine 110 contributes more accurate data to a CA model, helping to estimate the environmental benefits of recycling or reusing the waste materials. This integration of the CF ensures that the waste management system not only tracks reusable materials accurately but also contributes to the broader goals of sustainability and carbon footprint reduction.

Further, the artificial intelligence based waste object categorizing engine 110 determines a visual characteristics of the waste item based on the confidence factor. The artificial intelligence based waste object categorizing engine 110 assigns a configurable Average Reusable Weight (ARW) to the waste item based on the visual characteristics of the waste item and the confidence factor.

The artificial intelligence based waste object categorizing engine 110 determines the visual characteristics of the waste item such as its shape, color, and texture by analyzing the image captured during disposal. Based on the confidence factor (CF), the artificial intelligence based waste object categorizing engine 110 indicates the certainty of the Al's classification. Further, the artificial intelligence based waste object categorizing engine 110 assesses the visual features of the item. For example, if the waste item is identified as a plastic bottle, the artificial intelligence based waste object categorizing engine 110 evaluates its distinct characteristics, such as the typical shape and labeling, and cross-references it with a database of known items. If the artificial intelligence based waste object categorizing engine 110 is highly confident (e.g., CF is 0.9), the artificial intelligence based waste object categorizing engine 110 classifies the plastic bottle with high accuracy. Subsequently, the artificial intelligence based waste object categorizing engine 110 assigns the configurable Average Reusable Weight (ARW) to the waste item. The ARW is based on both the visual characteristics (indicating it is made of recyclable PET plastic) and the confidence factor, ensuring that the item is categorized with an appropriate weight value for recyclable materials. For example, if the confidence factor is high, the ARW for the plastic bottle might be set at 0.15 kg, reflecting its weight as a recyclable material.

Further, the artificial intelligence based waste object categorizing engine 110 determines a Clustered Disposal Event (CDE). The artificial intelligence based waste object categorizing engine 110 performs a waste diversion activity for the CDE to identify a category of the waste item. The category includes at least one of: a purchased goods category, a purchased service category, a sold product category, the waste item for lessee, the waste item for a lessor, the waste item for franchises, the waste item for a financial institution, the waste item for end-of-life treatment of sold products.

When the user disposes of various items such as a cardboard packaging, a plastic bottle, and a used appliance, the artificial intelligence based waste object categorizing engine 110 groups these individual disposal events into a single CDE based on the proximity and type of waste. The artificial intelligence based waste object categorizing engine 110 then performs the waste diversion activity for the CDE, and analyzes the characteristics of each waste item to identify the appropriate category. For instance, the plastic bottle is categorized under the purchased goods category, while the used appliance is classified under the sold product category. If the artificial intelligence based waste object categorizing engine 110 detects that the waste item belongs to a franchise, like a branded coffee cup, it might classify it under the waste item for franchises category. Similarly, the cardboard packaging might be identified as related to end-of-life treatment of sold products, ensuring that it is handled appropriately for recycling. This categorization helps streamline the sorting, recycling, and disposal process, ensuring that each item is diverted to the correct waste management stream based on its origin or intended treatment, which could include manufacturers, venues, lessees, lessors, franchise operators, or financial institutions involved in the product lifecycle.

Further, the artificial intelligence based waste object categorizing engine 110 indicates the weight of the waste stream to a vehicle operator and a third party so as to maximize usage of a vehicle. For instance, if the large number of recyclable items like plastic bottles, metal cans, and cardboard are disposed of, the artificial intelligence based waste object categorizing engine 110 determines the total weight of these materials in the waste stream. This information is then communicated to the vehicle operator and the third party (such as a waste management service or recycling facility) in order to maximize the usage of a waste collection vehicle. The artificial intelligence based waste object categorizing engine 110 sends a notification with the total weight of the waste to the vehicle operator's dashboard, allows them to adjust the collection schedule or optimize the vehicle's capacity before heading to the designated drop-off or recycling location. The third party also receives the weight data, enables them to prepare for the incoming delivery of recyclables, ensures that the facility is ready to handle the load efficiently. By sharing this data, the artificial intelligence based waste object categorizing engine 110 helps streamline the waste collection process, reduces unnecessary trips, optimizes vehicle load capacity, and improves overall operational efficiency in the waste management system.

The artificial intelligence based waste object categorizing engine 110 also alerts a service provider and the third party to visit and change a trash bag associated with the first waste bin and the second waste bin. In an example, when the artificial intelligence based waste object categorizing engine 110 detects that the waste level has reached a certain threshold or that the trash bags are nearing capacity such as when the first bin is filled with recyclables and the second bin is overflowing with organic waste, the artificial intelligence based waste object categorizing engine 110 generates an alert. This alert is sent to both the service provider responsible for waste collection and the third party managing the recycling or composting process. The notification includes specific details about the bins, such as their locations, the types of waste, and the urgency of changing the trash bags to prevent overflows or contamination. For instance, the service provider might receive a message indicating that the trash bag in the first waste bin is full of recyclable materials, and the second waste bin is filled with food waste, requiring a change before the bins reach capacity. By sending these proactive alerts, the artificial intelligence based waste object categorizing engine 110 ensures that waste management is timely and efficient, preventing waste spillage and maintaining proper waste sorting.

Further, the artificial intelligence based waste object categorizing engine 110 assigns an attribute associated with an event. The event can be, for example, but not limited to a calendar event, a sports event, a government related event, a musical event, a movie related event, and a traveling event.

The artificial intelligence based waste object categorizing engine 110 not only classifies waste but also assigns relevant attributes to the waste disposal events based on specific contexts. For example, if a large public sports event like a football game is taking place, the artificial intelligence based waste object categorizing engine 110 detects an increase in waste disposal around the stadium and assigns an event attribute to the waste stream associated with the sport. The artificial intelligence based waste object categorizing engine 110 might recognize that a significant amount of disposable cups, snack wrappers, and plastic bottles are being discarded and links this waste activity to the sports event. Similarly, if waste is being disposed of during a movie-related event, such as a film festival, the artificial intelligence based waste object categorizing engine 110 could identify that a higher volume of popcorn containers and drink bottles are being discarded, categorizing this as part of the movie-related event. By assigning event-specific attributes, the artificial intelligence based waste object categorizing engine 110 can provide valuable insights to waste management teams, enabling them to optimize collection schedules and recycling efforts based on the type and scale of the event. This also helps in tracking the environmental impact and ensuring that waste disposal practices are tailored to the specific needs of each event.

Based on the attribute associated with the event, the artificial intelligence based waste object categorizing engine 110 identifies and displays the brand, the product, the material, the usage of the material, the service information, and the waste stream type in the first waste bin and the second waste bin.

Also, the artificial intelligence based waste object categorizing engine 110 classifies and rates the waste stream type in the first waste bin and the second waste bin based on the attribute associated with the event. The artificial intelligence based waste object categorizing engine 110 determines the weight of the waste stream type in the first waste bin and the second waste bin based on the attribute associated with the event.

The artificial intelligence based waste object categorizing engine 110 computes a scale data. The scale data is the data regarding the presence of the waste item, as well as the aggregate weight of the waste item (and when the item is known, and is known to have more than one component, the constituent component weights also become “scale data”).

By differentiating between Material Disposal Events (MDEs) generated as an outcome of computer vision, irrespective of whether a controlled supply chain operates in a controlled environment or not, the artificial intelligence-based waste object categorizing engine 110 determines a Certified Material Disposal Event (CMDE). This determination is made using a variety of computational techniques, including but not limited to material-specific and average-data calculation techniques. When these MDEs are clustered together to represent a Metric Tonne, the resulting aggregation is referred to as a Certified Clustered Material Event (CCME).

Similarly, a Verified Material Disposal Event (VMDE) is achieved under the supervision of a knowledgeable individual separating waste materials, utilizing the same calculation methods as previously described. When the VMDEs are aggregated to represent a Metric Tonne, the resulting event is referred to as a Verified Clustered Material Event (VCME). For example, kitchen staff separating food waste from reusable food packaging in the back of the kitchen, scraping food scraps into the connected bin, generates Verified MDEs. These MDEs are time-stamped, the weight is calculated, and once the Metric Tonne threshold is reached, the data is aggregated and clustered to form a VCME, which is then tied to all relevant stakeholders.

Further, the artificial intelligence-based waste object categorizing engine 110 generates a standard Material Disposal Event (SMDE) when a configurable weight variance is achieved on scales to account for changes in weight, with configurable confidence and contamination factors. When these SMDEs are clustered to represent a Metric Tonne, typically using an average-data calculation method, the resulting event is referred to as a Clustered Material Event (CME). This allows us to establish differing confidence factors and contamination rates across the different classes of SMDEs creating a more harmonious overview of Material Flow Analysis for the purposes of Sustainable Materials Management.

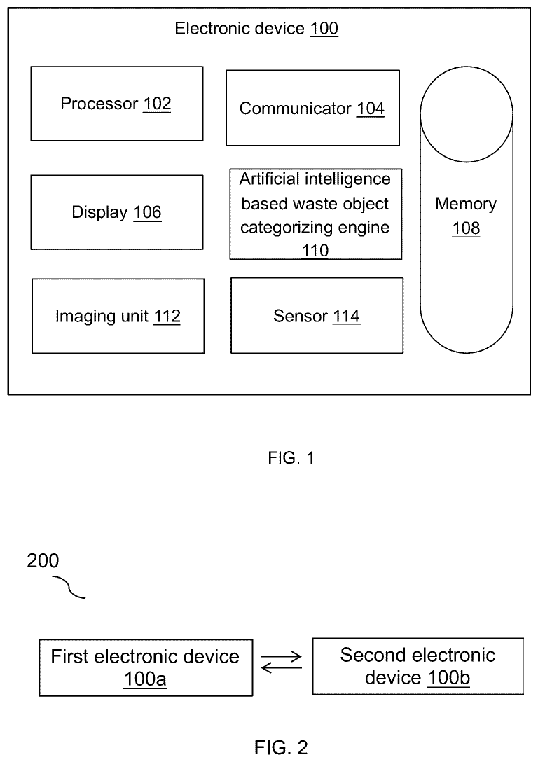

The communicator 104 is configured to communicate with internal units and with external devices via one or more networks or a second electronic device (illustrated in the FIG. 2). The memory 108 may include one or more computer-readable storage media. Accordingly, the memory 108 may include non-volatile storage elements. Examples of such non-volatile storage elements may include magnetic hard disc, optical discs, floppy discs, flash memories, or forms of electrically programmable memories (EPROM) or electrically erasable and programmable (EEPROM) memories. In addition, the memory 108 may, in some examples, be considered a non-transitory storage medium. The term “non-transitory” may indicate that the storage medium is not embodied in a carrier wave or a propagated signal. However, the term “non-transitory” should not be interpreted that the memory 108 is non-movable.

Although FIG. 1 shows various units of the electronic device 100, it is understood by those of skill in the art upon reading this disclosure that other embodiments are not limited thereon. In other embodiments, the electronic device 100 may include less or more number of various units. Further, the labels or names of the various units are used only for illustration purpose and does not limit the scope of the invention. One or more units can be combined together to perform same or substantially similar function to manage the waste.

FIG. 2 is a block diagram of a system 200 for waste management. In one embodiment, the system 200 includes a first electronic device 100a and a second electronic device 100b. The first electronic device 100a transfers the at least one image to the second electronic device 100b in real-time, in near real-time, or in a recorded format. After receiving the at least one image from the first electronic device 100a, the second electronic device 100b performs the various operations to manage the waste. The operations and functions of the second electronic device 100b are previously explained in conjunction with the FIG. 1.

FIG. 2 shows the limited overview of the system 200 but, it is readily understood to those of skill in the art upon reading this disclosure that other embodiments are not so limited. Further, the system 200 can include any number of hardware or software components communicating with each other.

FIG. 3 is a block diagram of the artificial intelligence based waste object categorizing engine 110 included in the electronic device 100 for waste management. In one embodiment, the artificial intelligence based waste object categorizing engine 110 includes an artificial intelligence model 302, a classifier 304, and a machine learning model 306. Additionally, the artificial intelligence model 302 includes a box generator 302a and a shape identifier 302b. The classifier 304 can be, for example, but not limited to a k-nearest neighbors (KNN) classifier. The machine learning model 306 can be, for example but not limited to, a supervised learning and deep learning based learning model and multilayer hybrid deep-learning based learning model.

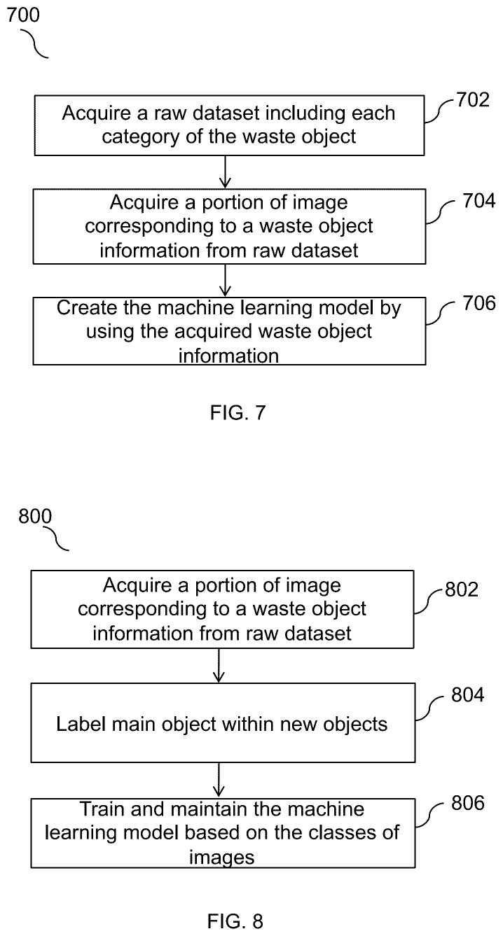

In an embodiment, the machine learning model 306 is configured to classify the waste objects in the raw images into high level groups such as metals, glass, cardboard, paper, Styrofoam, food, plastic, etc. to direct, reward, educate and align context with content. The artificial intelligence model 302 requires training examples prior to classification, allows the machine learning model 306 to associate specific combinations of object vectors with specific classes types. The result of this stage of the artificial intelligence model 302 during runtime operation is an overall classification for the object based on the configured categories. The waste object will be deposited based on the classification. Additionally, objects not falling under current classifications will be fed into the machine learning routine, described in FIG. 7 and FIG. 8, to further train the system and expand on possible classification brackets.

The box generator 302a outputs a set of bounding boxes related to the waste information, where each bounding boxes defines the location, size and category label of the waste object. The box generator 302a generates a clear boundary for a physical characteristics corresponding to the waste object. In an example, an icon size and an icon share are visually varied based on an intensity of the physical characteristics corresponding to the waste object. The shape generator 302b outputs predicted shapes and intensity of the physical characteristics corresponding to the waste object. The box generator 302a and the shape generator 302b can operate individually either in series or parallel or as a single entity. The classifier 304 classifies the pixel value features into classes using an unsupervised learning model.

In an embodiment, a framework performs a machine learning procedure to train the classifier 306 using a training image pixel dataset. The classifier 304 is applied to image pixel(s) to identify one or more different pixels, which may then be corrected. The artificial intelligence model 302 and the machine learning model 306 receive one or more training image datasets from a reference imaging system. Alternatively, the artificial intelligence model 302 and the machine learning model 306 may use or incorporate training and implementation to “teach”, modify and implement identification of waste materials.

In another embodiment, the artificial intelligence model 302 uses a convolutional neural network (CNN)-based technique to extract the features corresponding to the image and a multilayer perceptron technique to consolidate image features to classify wastes as recyclable, trash, compost or the others. The multilayer perceptron technique is trained and validated against the manually labelled waste objects. Further, the artificial intelligence model 302 acts as a response center to classify the waste object by consolidating information collected from the imaging unit 112.

In another embodiment, the machine learning model 306 can be a layer based neural network (e.g., 4 layer deep learning network, 5 layer neural network or the like) and train it for a predictive analysis. For example, the 4 layer based neural network has 32, 16, 10 and 4 nodes at each level for achieving deep learning for the waste object prediction. The predict function will pass feature vector set to the neural network and produce the output as seen in FIG. 4. As shown in the FIG. 4, the layers between a first layer (i.e., input layer) and a last layer (i.e., output layer) are called as hidden layers. All layers are used to process and predict the waste object. In another example, 4 layer neural network is used for waste object prediction in which last layer (i.e., output layer will have 6 nodes for predicting the waste object). In general, the neural network has 1^{st} layer including 32 nodes, 2^{nd} layer corresponding to 16 nodes, last layer including 5 nodes or 6 nodes for predicting the waste object.

In another embodiment, the machine learning model 306 is created by a tenser flow library. Initially, the machine learning model 306 builds a data set of m-set of waste objects which is created by getting and tagging information across Internet for the waste classification. Further, the machine learning model 306 extracts the features of the waste objects in the dataset. From the tenser flow library model, the machine learning model 306 will co-relate the waste object belongs to which category. In an example, the waste predicted through the machine learning model 306 are recyclable, trash, compost.

In an embodiment, the accuracy and the speed of the machine learning model 306 varies based on amount of raw dataset the machine learning model 306 is trained on. In another embodiment, the accuracy and the speed of the machine learning model 306 varies based on a frame rate, overall CPU power, a GPU power or the like.

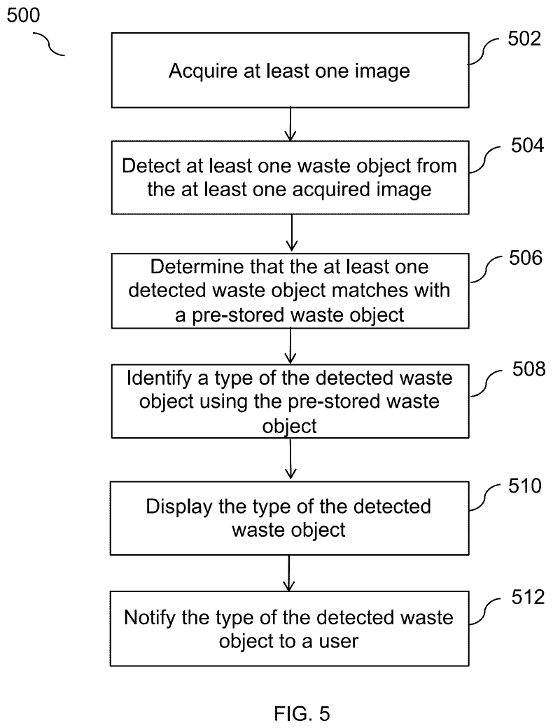

FIG. 5 is a flow chart 500 illustrating a method for waste management, in accordance with an embodiment of the present invention. The operations 502-512 are performed by the artificial intelligence based waste object categorizing engine 110.

In act 502 the method comprises acquiring the at least one image. At act 504, the method includes detecting the at least one waste object from the at least one acquired image. Then, in act 506, the method includes determining that the at least one detected waste object matches with the pre-stored waste object. Next, in act 508 the method includes identifying the type of the detected waste object using the pre-stored waste object. At act 510, the method includes displaying the type of the detected waste object based on the identification. And, in act 512 the method includes notifying the type of the detected waste object to the user.

The proposed method can be used to direct the user behavior for waste sorting using the AI based computer vision techniques. The proposed method can be used to evaluate and sort waste into desired categories, i.e., recyclables, trash and compost. The proposed method can be implemented in a trash disposal at many location (e.g., office spaces, apartments, recreational area, stadiums, home, public places, park, street cleaning, or the like). The proposed method can be used by a user (e.g., technicians, agriculture user, food court servant, pedestrian, or the like).

The proposed method can be used to capture the visual information of the user carrying the waste object to analyze and sort waste into the right stream and provide a visual alert (through LED's and on-screen messaging) or audio message to the user, so as to automatically sort waste disposed of by the user.

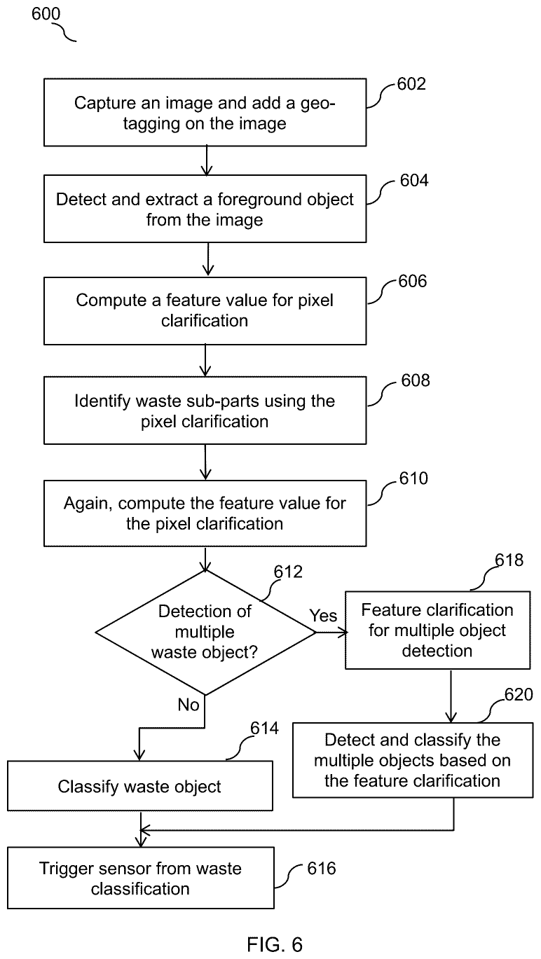

FIG. 6 is an example flow chart 600 illustrating various operations for waste management.

Starting in act 602 the method includes capturing the image and adding the geo-tagging on the image. As an example, the camera captures the image and adds the geo-tagging on the image.

In an act 604 the method includes detecting and extracting the foreground object from the acquired image. As an example, the artificial intelligence based waste object categorizing engine 110 detects and extracts the main objects and sub-images from the acquired raw image and separates the background portion from the acquired raw image.

At act 606, the method includes computing the feature value corresponding to the feature parameter for the pixel clarification associated with the acquired raw image. In an example, the artificial intelligence based waste object categorizing engine 110 computes the feature value corresponding to the feature parameter for the pixel clarification associated with the acquired raw image using the shape of the waste object and color of the waste object.

Then, in act 608 the method includes identifying the waste sub-parts using the pixel clarification. As an example, the artificial intelligence based waste object categorizing engine 110 identifies the waste sub-parts using the pixel clarification.

Next, in act 610, the method again computes the feature value corresponding to the feature parameter for the pixel clarification. As an example, the artificial intelligence based waste object categorizing engine 110 again computes the feature value corresponding to the feature parameter for the pixel clarification.

At query 612, the method can determine whether multiple waste objects are detected. If multiple waste objects are not detected then, in an act 614, \ the method includes classifying the waste object. As an example, the artificial intelligence based waste object categorizing engine 110 may classify the waste object.

Then, at act 616 the method includes triggering the sensor 114 from the waste classification. As an example, the processor 102 triggers the sensor 114 for the waste classification.

Alternatively from the query 612, if multiple waste objects are detected then, at an act 618 the method includes performing the feature clarification corresponding to the features values for multiple object detection. In an example, the artificial intelligence based waste object categorizing engine 110 performs the feature clarification corresponding to the features values for multiple object detection.

After act 618, the method proceeds to act 620 which includes detecting and classifying the multiple objects based on the feature clarification. As an example, the artificial intelligence based waste object categorizing engine 110 detects and classifies the multiple objects based on the feature clarification.

FIG. 7 is a flow chart illustrating various operations for creating the machine learning model 306 in conjunction with FIG. 5. The operations 702-706 are performed by the artificial intelligence model 302.

The method 700 starts in act 702 which includes acquiring a raw dataset including the set of waste object along with various categories. Next, in an act 704, the method includes acquiring the portion of the image corresponding to the waste object from the raw dataset. Then, in act 706 the method includes creating the machine learning model by using the acquired waste object information. The machine learning model is trained based on a frame rate, overall CPU power, a GPU power, or the like.

FIG. 8 is a flow chart illustrating various operations for training and maintaining the machine learning model 306 in connection with the FIG. 5, in accordance with an embodiment of the present invention. The operations 802-806 are performed by the artificial intelligence model 302.

First, in an act 802 the method includes acquiring the portion of the image corresponding to the waste object from the raw dataset. Next in an act 804 the method includes labelling the main object within the waste objects. Then, in act 806 the method includes training and maintaining the machine learning model based on the labelled main object. The labelled main object includes multiple class of the images corresponding to the waste object.

The various actions, acts, blocks, steps, or the like in the flow diagram 500-800 may be performed in the order presented, in a different order or simultaneously. Further, in some embodiments, some of the actions, acts, blocks, steps, or the like may be omitted, added, modified, skipped, or the like without departing from the scope of the invention.

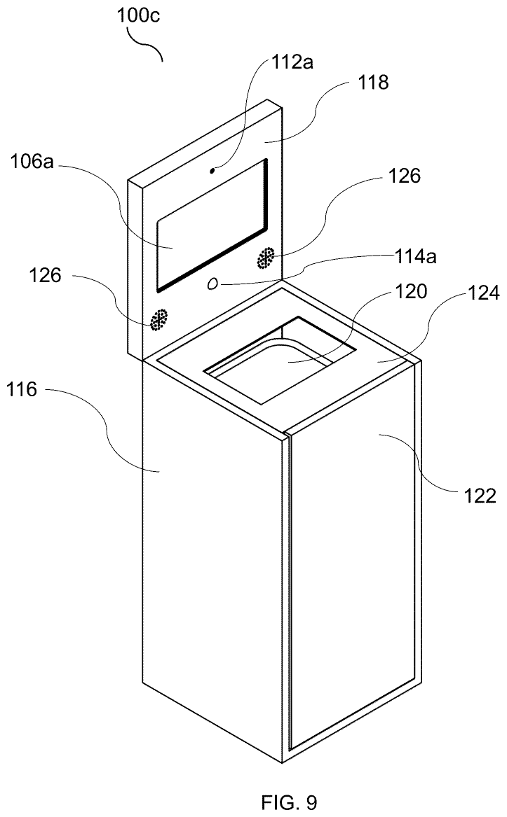

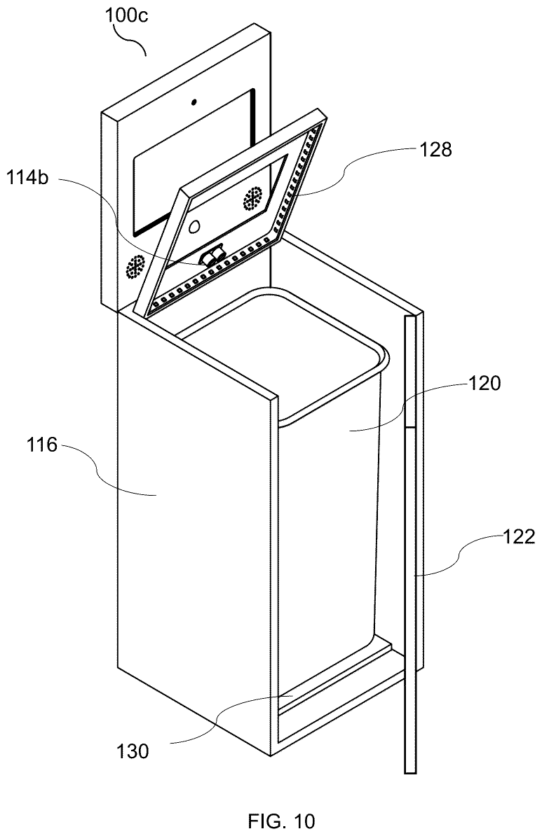

Simultaneous reference is made to FIG. 9 and FIG. 10, which are perspective views of a smart bin wastage sort device 100c, that incorporate the above teachings of the invention. The smart bin wastage sort device 100c is an example of an electronic device 100. Specifically, substantial operations and functions of the electronic device 100 are previously explained in conjunction with the FIG. 1 to FIG. 8.

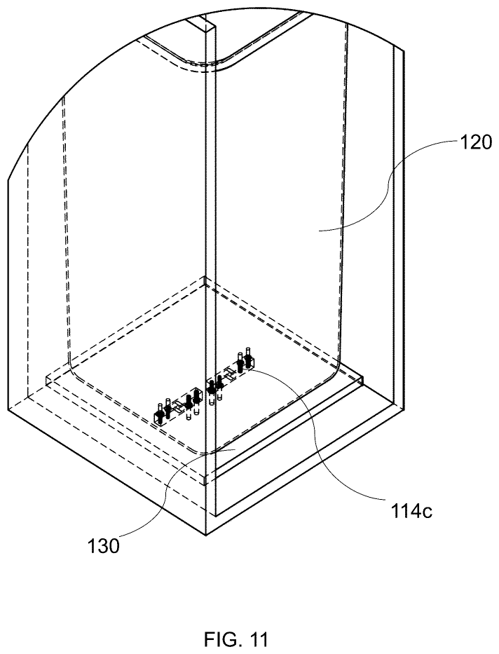

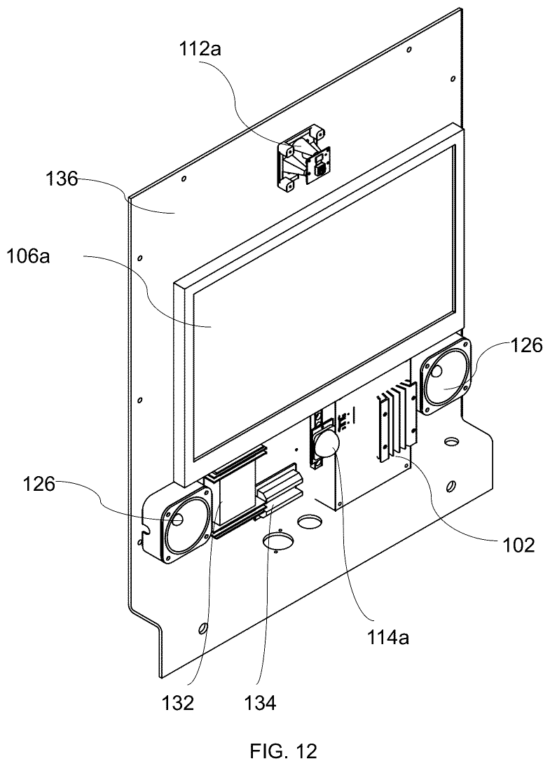

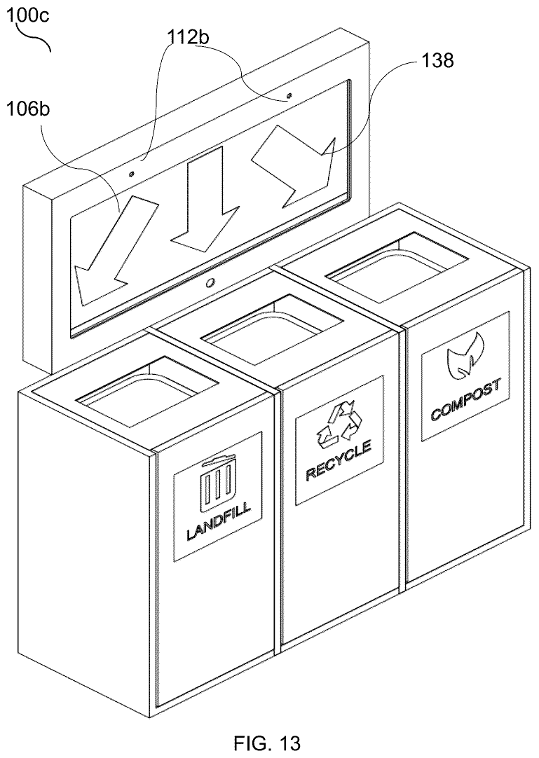

As shown in the FIG. 9 and FIG. 10 the smart bin wastage sort device 100c includes a bin housing 116, a smart bin back panel 118, a collection can 120, a bin housing door 122, a bin housing lid with an opening 124, a digital camera 112a, an information display 106a, a distance sensor 114a, a speaker 126, an optical indicator 128, a fill level sensor 114b, an electronic scale 130, a strain gauges 114c (Shown in FIG. 11), the processor 102 (Shown in FIG. 12), a power supply 132 (Shown in FIG. 12), a power distribution board 134 (Shown in FIG. 12), a mounting plate 136 (Shown in FIG. 12), a visual indicator 138 for direction (Shown in FIG. 13), a digital camera array 112b for wider field of vision (Shown in FIG. 13), and a wide screen information display 106b (Shown in FIG. 13). The device shown is preferably sized for home or public use, such as in an airport, sports facility (such as a stadium, for example), school or office location such as a hallway, break room, or restroom, for example.

The bin housing 116 includes the collection can 120 for collecting all types of waste material. The smart bin back panel 118 is attached with a top portion of the bin housing 116, and covers the top portion of the bin housing 116. The bin housing door 122 is provided with the bin housing 116, and the bin housing 116 includes the bin housing lid with the opening 124 for accessing and keeping the waste in the collection can 120.

The digital camera 112a captures the image of the waste and the information display 106a displays the type of the waste. The distance sensor 114a measures the distance between the user and the smart bin wastage sort device 100a. The speaker 126 informs the type of the waste to the user.

As shown in more detail in FIG. 10, the optical indicator 128 indicates the type of the waste to the user and the fill level sensor 114b measures the level of the waste stored in the collection can 120. The electronic scale 130 is provided in bottom of the collection can 120.

FIG. 11 is a partial sectional view of the collection can 120 included in the smart bin wastage sort device 100c. As shown in the FIG. 11, the strain gauges 114c measures the weight of the waste stored in the collection can 120. The processor 102 is coupled with various elements (e.g., the collection can 120, the bin housing door 122, the bin housing lid with the opening 124, the digital camera 112a, the information display 106a, the distance sensor 114a, the speaker 126, the optical indicator 128, the fill level sensor 114b, the electronic scale 130, and the strain gauges 114c) in the smart bin wastage sort device 100a.

FIG. 12 is a perspective view of the smart bin back panel 118 included in the smart bin wastage sort device 100c, in accordance with an embodiment of the present invention. As shown in the FIG. 12, the power supply 132 supplies the power in the smart bin wastage sort device 100a through the power distribution board 134. The mounting plate 136 is provided in the smart bin back panel 118.

FIG. 13 is a perspective view of the smart bin wastage sort device 100c including the visual indicator 138, in accordance with an embodiment of the present invention. As shown in the FIG. 13, the visual indicator 138 indicates the direction to the user for waste disposal and the digital camera array 112b is used for wider field of vision. The wide screen information display 106b displays information related to the waste.

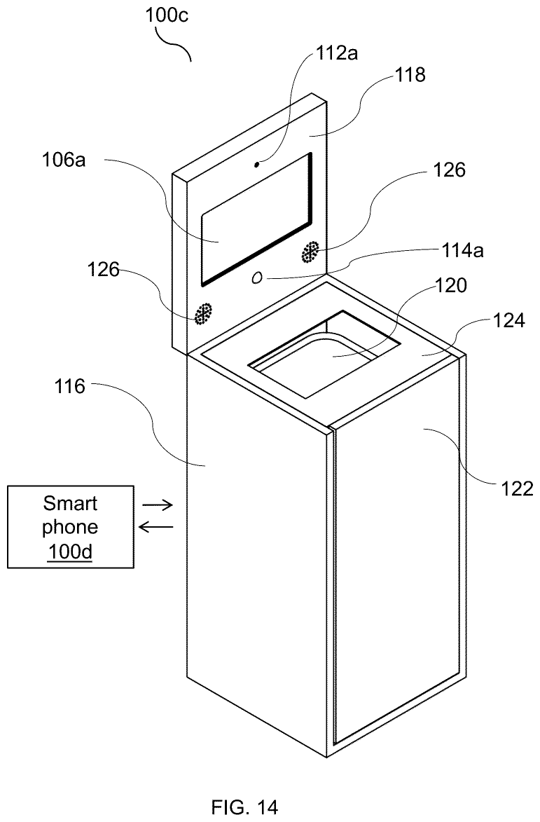

FIG. 14 is schematic view of an example system in which the smart bin wastage sort device 100c communicates with a smart phone 100d for waste management, in accordance with an embodiment of the present invention.

In one embodiment, the system includes the the smart bin wastage sort device 100c and the smart phone 100d. The smart bin wastage sort device 100c transfers the at least one image to the smart phone 100d in real-time or in near real-time or in a recorded format. After receiving the at least one image from the smart bin wastage sort device 100c, the smart phone 100d performs the various operations to manage the waste. The operations and functions of the smart phone 100d are substantially explained in conjunction with the FIG. 1, FIG. 2 and FIG. 9 to FIG. 13.

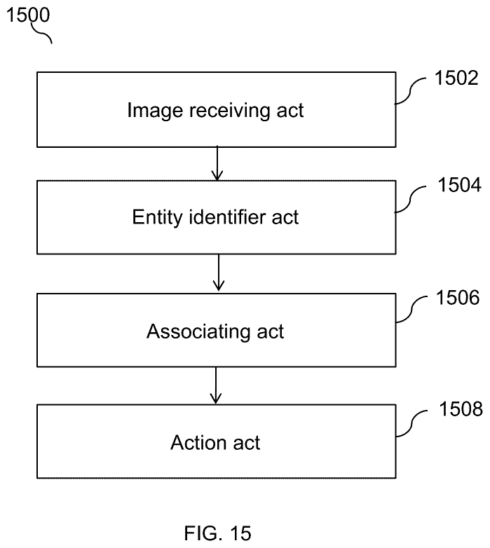

FIG. 15 is an example flow chart 1500 illustrating various operations for waste management. FIG. 15 may be read in conjunction with FIG. 1. At an image receiving act 1502, the method includes receiving the image of the waste item/object while detecting the WDA on the first waste bin 1602 and the second waste bin 1604. At an entity identifier act 1504, the method includes generating the EID during the MDE. At an associating act 1506, the method includes associating the entity identifier with the material disposal event (MDE) generated during the waste disposal activity. At an action act 1508, the method includes performing an action based on the entity identifier.

The action can be, for example, identifying and displaying the brand, the product, the material, the usage of the material and the service information from the received image using the data driven assisted vision-based component. Alternatively, the action can be, for example, identifying the waste stream type in the first waste bin and the second waste bin. Alternatively, the action can be, for example, classifying and rating the waste stream type in the first waste bin and the second waste bin. Alternatively, the action can be, for example, determining the weight of the waste stream type in the first waste bin and the second waste bin.

FIG. 16 is an example illustration 1600 in which a system handles the waste management. FIG. 16 may be read in conjunction with FIG. 1. As mentioned earlier, the cloud synchronization service (e.g., proprietary cloud synchronization or the like) is performed, at the cloud storage component (e.g., non-relational cloud storage 1606), for the integrated bin 1602 and the connected bin 1604. The integrated bin 1602 includes the local DB (i.e., local database or local repository) 1612, and the connected bin 1604 includes the local DB (i.e., local database or local repository) 1616. By using the artificial intelligence based waste object categorizing engine 110, the integrated bin 1602 handles material identification process and a post-identification process for the waste item and the connected bin 1604 handles the post-identification process for the waste item.

The post-identification process includes detecting the waste object from the acquired image based on the foreground portion of the acquired image, and the background portion of the acquired image deriving the feature parameter therefrom. The post-identification process further includes determining the feature value corresponding to the feature parameter for pixel clarification associated with the acquired image. The post-identification process includes determining whether the detected waste object matches with the pre-stored waste object. Further, the post-identification process includes identifying a type of the detected waste object using the pre-stored waste object, when the detected waste object matches with the pre-stored waste object. Alternatively, when the detected waste object is not matched with the pre-stored waste object, the post-identification process includes placing the detected waste object in the queuing library to manually create the new classification for the unknown object, or properly align the detected waste object with the correct classification in the pre-stored waste object. Further, the post-identification process includes adding the new classification to the artificial intelligence based waste object categorizing engine to continue the training process.

The material identification process includes receiving the image while detecting the WDA at the integrated bin 1602 and the connected bin 1604. The material identification process includes generating the EID during the MDE and associating the entity identifier with the material disposal event generated during the waste disposal activity. Based on the entity identifier, the material identification process identifies and displays the brand, the product, the material, the usage of the material and the service information from the received image using the data driven assisted vision-based component.

Alternatively, the material identification process identifies the waste stream type in the integrated waste bin and the connected waste bin. Alternatively, the material identification process classifies and rates the waste stream type in the integrated waste bin and the connected waste bin. Alternatively, the material identification process determines the weight of the waste stream type in the integrated waste bin and the connected waste bin.

The material identification process computes the average reusable weight factor across the plurality of waste items based on the material disposal event. Further, the material identification process configures the CF for the RMA process and the CA purpose.

The material identification process assigns the configurable ARW to the waste item based on the visual characteristics of the waste item and the confidence factor.

The material identification process also includes performing the waste diversion activity for the clustered disposal event to identify the category of the waste item.

Further, the material identification process helps in indicating the weight of the waste stream to the vehicle operator and the third party so as to maximize usage of the vehicle. Also, the material identification process includes alerting the service provider and the third party to visit and change the trash bag associated with the integrated waste bin and the connected waste bin. The material identification process facilitates assigning the attribute associated with the event.

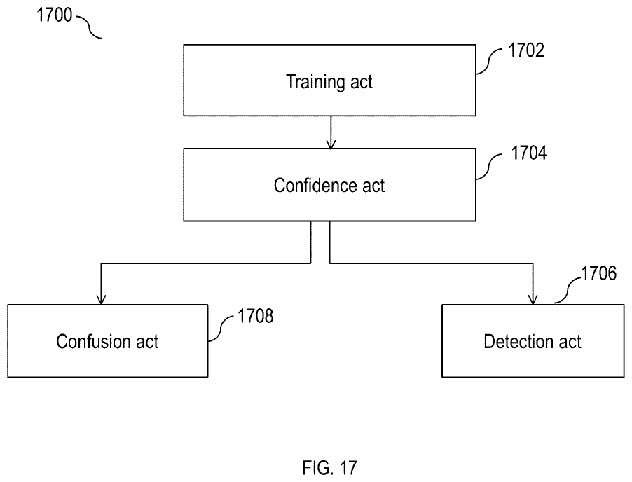

FIG. 17 is an example flow chart 1700 illustrating a method for training the machine learning model used in the the artificial intelligence based waste object categorizing engine 110. At a training act 1702, the method includes training various material classes and brands of the waste items/objects. At a confidence act 1704, the method includes identifying a confidence level to determine the material classes and the brands from the image of the waste item/object. If the confidence level is high, then at a detection act 1706, the method includes detecting the material classes and the brands accurately from the image of the waste item/object. If the confidence level is low, then at a confusion act 1708, the low confidence detections feed the MDE data to a queuing library for further training the material classes and the brands.

Also, when the confidence level is low, the confusion act 1708 includes the option to place the detected waste object in the library to either manually create a new classification for an unknown object, or properly align the detected waste object with a correct classification in a pre-stored waste object and then add to the artificial intelligence based waste object categorizing engine 110 to continue the artificial intelligence training process.

Although the invention has been explained in relation to its preferred embodiment, it is to be understood that many other possible modifications and variations can be made without departing from the spirit and scope of the invention. Upon reading this disclosure, changes, modifications, and substitutions may be made by those skilled in the art to achieve the same purpose the invention. The exemplary embodiments are merely examples and are not intended to limit the scope of the invention. It is intended that the present invention cover all other embodiments that are within the scope of the descriptions and their equivalents.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The networked electronic devices described herein may be in the form of a mobile communication device (e.g., a cell phone), laptop, tablet computer, interactive television, game console, media streaming device, head-wearable display, virtual or augmented reality device, networked watch, etc. The networked devices may optionally include displays, user input devices (e.g., touchscreen, keyboard, mouse, voice recognition, etc.), network interfaces, etc.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

What is claimed is:

1. A method for handling a waste management, comprising:
providing at least one first waste bin and at least one second waste bin, wherein the at least one first waste bin has a local repository and the at least one second waste bin has a local repository, wherein the at least one first waste bin has a data driven assisted vision-based component;
receiving, by an electronic device, at least one image while detecting a waste disposal activity (WDA) on the at least one first waste bin and the at least one second waste bin;
generating, by the electronic device, an entity identifier (EID) during at least one material disposal event (MDE);
associating, by the electronic device, the at least one entity identifier with the at least one material disposal event generated during the waste disposal activity; and
performing, by the electronic device, at least one of:
identifying at least one of: a brand, a product, a material, a usage of the material and a service information from the received image using the data driven assisted vision-based component based on the at least one entity identifier,
displaying at least one of: the identified brand, the identified product, the identified material, the identified usage of the material and the identified service information using the data driven assisted vision-based component,
identifying a waste stream type in at least one of: the at least one first waste bin and the at least one second waste bin,
classifying and rating the waste stream type in at least one of: the at least one first waste bin and the at least one second waste bin, and
determining a weight of the waste stream type in at least one of: the at least one first waste bin and the at least one second waste bin.

2. The method of claim 1, wherein the method comprises:
performing, by the electronic device, a proprietary cloud synchronization, at a cloud storage component, for the at least one first waste bin and the at least one second waste bin;
determining, by the electronic device, at least one synchronization feedback associated with the proprietary cloud synchronization for the at least one first waste bin and the at least one second waste bin; and
performing, by the electronic device, at least one of:
optimizing to identify at least one of: the brand, the product, the material, the usage of the material and the service information using the data driven assisted vision-based component based on the at least one synchronization feedback,
optimizing to display at least one of: the identified brand, the identified product, the identified material, the identified usage of the material and the identified service information using the data driven assisted vision-based component based on the at least one synchronization feedback,
optimizing to identify the waste stream type in at least one of: the at least one first waste bin and the at least one second waste bin based on the at least one synchronization feedback,
optimizing to classify and rate the waste stream type in at least one of: the at least one first waste bin and the at least one second waste bin based on the at least one synchronization feedback, and
optimizing to determine a weight of the waste stream type in at least one of: the at least one first waste bin and the at least one second waste bin based on the at least one synchronization feedback.

3. The method of claim 1, wherein the method comprises computing, by the electronic device, an average reusable weight factor across a plurality of waste items based on the at least one material disposal event.

4. The method of claim 1, wherein the method comprises:
configuring, by the electronic device, a confidence factor (CF) for at least one of: a reusable materials accounting (RMA) process and a Carbon Accounting (CA) purpose, wherein the confidence factor determines the at least one MDE being sent for further analysis to enhance accuracy of the data driven assisted vision-based component.

5. The method of claim 4, wherein the method comprises:
determining, by the electronic device, a visual characteristics of the at least one waste item based on the confidence factor; and
assigning, by the electronic device, a configurable Average Reusable Weight (ARW) to the at least one waste item based on the visual characteristics of the at least one waste item and the confidence factor.

6. The method of claim 4, wherein the confidence factor determines at least one content associated with the at least one waste item to be identified after at least one object detection received from the data driven assisted vision-based component.

7. The method of claim 4, wherein the confidence factor is trained based on the data driven assisted vision-based component over a period of time.

8. The method of claim 1, wherein the method comprises:
determining, by the electronic device, at least one Clustered Disposal Event (CDE); and
performing, by the electronic device, at least one waste diversion activity for the at least one Clustered Disposal Event to identify at least one category of at least one waste item, wherein the at least one category comprises at least one of: a purchased goods category, a purchased service category, a sold product category, the at least one waste item for lessee, the at least one waste item for a lessor, the at least one waste item for franchises, the at least one waste item for a financial institution, the at least one waste item for end-of-life treatment of sold products, and the at least one waste item for waste generated in operations.

9. The method of claim 1, wherein the method comprises:
indicating, by the electronic device, the weight of the waste stream to at least one of: a vehicle operator and a third party so as to maximize usage of a vehicle.

10. The method of claim 1, wherein the method comprises
alerting, by the electronic device, at least one of: a service provider and a third party to visit and change a trash bag associated with the at least one first waste bin and the at least one second waste bin.

11. The method of claim 1, wherein the method comprises:
assigning, by the electronic device, at least one attribute associated with at least one event, wherein the at least one event comprises at least one of: a calendar event, a sports event, a government related event, a musical event, a movie related event, and a traveling event;
performing, by the electronic device, at least one of:
identifying at least one of: the brand, the product, the material, the usage of the material and the service information based on the at least one attribute associated with the at least one event,
displaying at least one of: the identified brand, the identified product, the identified material, the identified usage of the material and the identified service information using the data driven assisted vision-based component,
identifying the waste stream type in at least one of: the at least one first waste bin and the at least one second waste bin based on the at least one attribute associated with the at least one event,
classifying and rating the waste stream type in at least one of: the at least one first waste bin and the at least one second waste bin based on the at least one attribute associated with the at least one event, and
determining the weight of the waste stream type in at least one of: the at least one first waste bin and the at least one second waste bin based on the at least one attribute associated with the at least one event.

12. The method of claim 1, wherein identifying, by the electronic device, the waste stream type in at least one of: the at least one first waste bin and the at least one second waste bin comprises:
acquiring the at least one image;
detecting at least one waste object from the at least one acquired image based on a foreground portion of the at least one acquired image, and a background portion of the at least one acquired image deriving at least one feature parameter therefrom;
determining a feature value corresponding to the at least one feature parameter for pixel clarification associated with the at least one acquired image;
determining that the at least one detected waste object matches with a pre-stored waste object;
performing at least one of:
identifying a type of the detected waste object using the pre-stored waste object;
when a detected waste object is not identified, placing the at least one detected waste object in a queuing library to:
manually create a new classification for an unknown object, or
properly align the at least one detected waste object with a correct classification in the pre-stored waste object, and then
adding the new classification to the artificial intelligence based waste object categorizing engine to continue a training process; and
identifying, by the electronic device, the waste stream type associated with the at least one detected waste object in at least one of: the at least one first waste bin and the at least one second waste bin based on the identification.

13. The method of claim 1, wherein
providing, by the electronic device, an option to place the at least one detected waste object in a library to either manually create a new classification for an unknown object, or properly align the at least one detected waste object with a correct classification in a pre-stored waste object and then add to an artificial intelligence based waste object categorizing engine to continue an artificial intelligence training process.

14. The method of claim 1, wherein the at least one Material Disposal Event (MDE) tracks the waste stream type with high granularity, so as to enable an advanced analytics and carbon accounting.

15. The method of claim 1, wherein the at least one Material Disposal Event (MDE) of the at least one first waste bin is associated with at least one of: a trash ID, a weight of the at least one waste item, an event associated with the at least one waste item, a total weight of the at least one first waste bin, an educational message, an advertisement, a material brand, and a user ID.

16. The method of claim 1, wherein the at least one Material Disposal Event (MDE) of the at least one second waste bin is associated with at least one of: a trash ID, a weight of the at least one waste item, an event associated with the at least one waste item and a total weight of the at least one second waste bin.

17. The method of claim 1, wherein the at least one first waste bin is an integrated waste bin and the at least one second waste bin is a connected waste bin.

18. An electronic device for handling a waste management, comprising:
a memory;
a processor, coupled with the memory; and
an artificial intelligence based waste object categorizing engine, coupled to the processor, configured to:
provide at least one first waste bin and at least one second waste bin, wherein the at least one first waste bin has a local repository and the at least one second waste bin has a local repository, wherein the at least one first waste bin has a data driven assisted vision-based component;
receive at least one image while detecting a waste disposal activity (WDA) on the at least one first waste bin and the at least one second waste bin;
generate an entity identifier (EID) during at least one material disposal event (MDE);
associate the at least one entity identifier with the at least one material disposal event generated during the waste disposal activity; and
perform at least one of:
identify at least one of: a brand, a product, a material, a usage of the material and a service information from the received image using the data driven assisted vision-based component based on the at least one entity identifier,
display at least one of: the identified brand, the identified product, the identified material, the identified usage of the material and the identified service information using the data driven assisted vision-based component,
identify a waste stream type in at least one of: the at least one first waste bin and the at least one second waste bin,
classify and rate the waste stream type in at least one of: the at least one first waste bin and the at least one second waste bin, and
determine a weight of the waste stream type in at least one of: the at least one first waste bin and the at least one second waste bin.
